(19) United States
(12) Patent Application Publication
(10) Pub. No.: US 2024/0373329 A1
(43) Pub. Date: Nov. 7, 2024

(54) Enabling Connections to Non-Public Networks

(71) Applicant: Telefonaktiebolaget LM Ericsson (publ), Stockholm (SE)

(72) Inventors: Daniel Mcgillivray, Vallda (SE); Yunpeng Zang, Würselen (DE); Tomas Nylander, Värmdö (SE)

(21) Appl. No.: 18/566,280

(22) PCT Filed: Jun. 9, 2021
(86) PCT No.: PCT/EP2021/065523

§ 371 Date: Dec. 1, 2023

(51) Int. Cl. H04W 48/16; H04W 4/44; H04W 12/06

(52) U.S. Cl. CPC H04W 48/16; H04W 4/44; H04W 12/06

(57) ABSTRACT

According to an aspect there is provided a method of operating a wireless device (102) that is connected to a public communication network (104). The method comprises receiving (1201), from a first server (106), network information relating to a non-public network. NPN (108), that is to be used by a service provider to provide a service to the wireless device (102), wherein the network information comprises a network identity of the NPN (108) and a credential for the NPN (108); following occurrence of a trigger, performing (1203) a network search for a network having the received network identity; connecting (1205) to the NPN (108); and authenticating (1207) to the NPN (108) using the received credential.

### TECHNICAL FIELD

This disclosure relates to non-public networks (NPNs), and in particular to techniques for enabling a wireless device that is connected to a public communication network to connect to a NPN.

### BACKGROUND

Many communication networks are considered to be public communication networks, in the sense that any person or enterprise can obtain a subscription to that network so that their wireless device(s) can connect to the public communication network and use services (e.g. voice, data and messaging) provided by that network. Public communication networks typically cover a significant geographical area and have many thousands or millions of subscribers. Some exemplary types of public communication networks operate according to one or more of the technologies standardised by the 3rd Generation Partnership Project (3GPP), such as Evolved Packet System (EPS), 5G System (5GS), Long Term Evolution (LTE) or New Radio (NR). Public communication networks are also known as Public Land Mobile Networks (PLMNs).

Recently, the concept of Non-Public Networks (NPNs) has been developed in which an enterprise (business) may set up their own communication network, and use the network to provide a specific service to, or via, wireless devices connected to the NPN. The enterprise operating the NPN may restrict access to the NPN to only certain wireless devices, for example wireless devices owned or managed by the same (or related) enterprise, or wireless devices that require, or are part of, the specific service provided by the enterprise. NPNs are also known as dedicated networks or private networks. As one example, an owner of a factory may have an NPN that is restricted for use by the wireless devices of their employees, and/or for use by wireless devices associated with sensors that are deployed in the factory to monitor various operational parameters of the factory and upload the measurements to the factory systems.

The automotive industry is also considering the use of private networks/NPNs, for example for parking facilities that provide Automatic Valet Parking (AVP), i.e. the automatic parking of a vehicle using remote operation of the vehicle by a parking computer system. Other similar use cases include vehicles accessing the NPN in an area where services like digital map provisioning, remote driving control or remote driving assistance are provided to vehicles via the NPN, e.g. in a logistic hub, at train stations, airports, seaports, in a mine, etc.

For AVP and the other use cases above, rather than restrict the use of the NPN to a specific set of wireless devices, which is the case for, for example, a factory owner, there is a need allow easy access to the NPN for subscribers/wireless devices that are to use the provided service and that are normally connected to a public communication network. However, providing easy access is complicated by the fact that these vehicles/wireless devices typically use public communication networks provided by different network operators, for example vehicles from different manufacturers may be subscribers of different public communication networks.

One problem with providing easy access to a NPN is that a vehicle/wireless device within the coverage area of the NPN, e.g. at a parking garage, will likely still have connectivity from its Home PLMN. This means that the vehicle/wireless device will not even attempt to connect to the NPN. One way to address this problem could be through roaming agreements and making the NPN an ‘equivalent PLMN’ of the Home PLMN, and modifying network configurations to facilitate the re-selection to the NPN. However this would be a major undertaking by network operators, which are in general reluctant to sign roaming agreements, and in this case there would need to be a multitude of roaming agreements with a number of parking facilities, and other services with an NPN. In addition it is problematic for a network operator to declare another network as an ‘equivalent PLMN’, and it would be costly to reconfigure the network to support this.

Another problem is that since there is no relationship between the public communication network being used by the vehicle/wireless device and the NPN, there are no common identifiers that can be used for authentication, i.e. compared to normal roaming, where the credentials provided by the Home PLMN (e.g. stored in a Subscriber Identity Module, SIM) are used to authenticate the wireless device when accessing another PLMN.

Therefore, there is a need for improved techniques for enabling a wireless device that is connected to a public communication network to connect to a NPN to receive a service.

### SUMMARY

According to a first aspect, there is provided a method of operating a wireless device that is connected to a public communication network. The method comprises: receiving, from a first server, network information relating to a non-public network, NPN, that is to be used by a service provider to provide a service to the wireless device, wherein the network information comprises a network identity of the NPN and a credential for the NPN; following occurrence of a trigger, performing a network search for a network having the received network identity; connecting to the NPN; and authenticating to the NPN using the received credential.

According to a second aspect, there is provided a method of operating a first server. The method comprises: sending, to a second server of a service provider, a request for network information relating to a non-public network, NPN, that is to be used by the service provider to provide a service to a wireless device; receiving, from the second server, network information comprising a network identity of the NPN and a credential for the NPN; and sending, to the wireless device, the received network information for the NPN for use by the wireless device to connect to, and authenticate with, the NPN.

According to a third aspect, there is provided a method of operating a second server of a service provider. The method comprises: receiving, from a first server, a request for network information relating to a non-public network, NPN, that is to be used by the service provider to provide a service to a wireless device; and sending, to the first server, the network information for the NPN, wherein the network information comprises a network identity and credential for the NPN.

According to a fourth aspect, there is provided a computer program product comprising a computer readable medium having computer readable code embodied therein. The computer readable code is configured such that, on execution by a suitable computer or processor, the computer or processor is caused to perform the method according to the first aspect, the second aspect, the third aspect or any embodiments thereof.

According to a fifth aspect, there is provided a wireless device configured to connect to a public communication network. The wireless device is configured to: receive, from a first server, network information relating to a non-public network, NPN, that is to be used by a service provider to provide a service to the wireless device, wherein the network information comprises a network identity of the NPN and a credential for the NPN; following occurrence of a trigger, perform a network search for a network having the received network identity; connect to the NPN; and authenticate to the NPN using the received credential.

According to a sixth aspect, there is provided a first server. The first server is configured to: send, to a second server of a service provider, a request for network information relating to a non-public network, NPN, that is to be used by the service provider to provide a service to a wireless device; receive, from the second server, network information comprising a network identity of the NPN and a credential for the NPN; and send, to the wireless device, the received network information for the NPN for use by the wireless device to connect to, and authenticate with, the NPN.

According to a seventh aspect, there is provided a second server. The second server is configured to: receive, from a first server, a request for network information relating to a non-public network, NPN, that is to be used by a service provider to provide a service to a wireless device; and send, to the first server, the network information for the NPN, wherein the network information comprises a network identity and credential for the NPN.

According to an eighth aspect, there is provided a wireless device. The wireless device comprises: at least one processor, and a memory containing program code executable by the at least one processor, whereby execution of the program code by the at least one processor causes the wireless device to perform a method according to the first aspect, or any embodiment thereof.

According to a ninth aspect, there is provided a first server. The first server comprises: at least one processor, and a memory containing program code executable by the at least one processor, whereby execution of the program code by the at least one processor causes the first server to perform a method according to the second aspect, or any embodiment thereof.

According to a tenth aspect, there is provided a second server. The second server comprises: at least one processor, and a memory containing program code executable by the at least one processor, whereby execution of the program code by the at least one processor causes the second server to perform a method according to the third aspect, or any embodiment thereof.

According to an eleventh aspect, there is provided a system comprising: a wireless device according to the fifth aspect, the eighth aspect, or any embodiments thereof; and a first server according to the sixth aspect, the ninth aspect, or any embodiment thereof.

According to a twelfth aspect, there is provided a method of operating a vehicle that is connected to a public communication network. The method comprises: receiving, from a vehicle server, network information relating to a non-public network, NPN, that is to be used by a service provider to provide a service to the vehicle, wherein the network information comprises a network identity of the NPN and a credential for the NPN; following occurrence of a trigger, performing a network search for a network having the received network identity; connecting to the NPN; and authenticating to the NPN using the received credential.

According to a thirteenth aspect, there is provided a method of operating a vehicle server. The method comprises: sending, to a second server of a service provider, a request for network information relating to a non-public network, NPN, that is to be used by the service provider to provide a service to a vehicle; receiving, from the second server, network information comprising a network identity of the NPN and a credential for the NPN; and sending, to the vehicle, the received network information for the NPN for use by the vehicle to connect to, and authenticate with, the NPN.

According to a fourteenth aspect, there is provided a method of operating a second server of a service provider. The method comprises: receiving, from a vehicle server, a request for network information relating to a non-public network, NPN, that is to be used by the service provider to provide a service to a vehicle; and sending, to the vehicle server, the network information for the NPN, wherein the network information comprises a network identity and credential for the NPN.

According to a fifteenth aspect, there is provided a computer program product comprising a computer readable medium having computer readable code embodied therein. The computer readable code is configured such that, on execution by a suitable computer or processor, the computer or processor is caused to perform the method according to the twelfth aspect, the thirteenth aspect, the fourteenth aspect, or any embodiments thereof.

According to a sixteenth aspect, there is provided a vehicle configured to connect to a public communication network. The vehicle is configured to: receive, from a vehicle server, network information relating to a non-public network, NPN, that is to be used by a service provider to provide a service to the vehicle, wherein the network information comprises a network identity of the NPN and a credential for the NPN; following occurrence of a trigger, perform a network search for a network having the received network identity; connect to the NPN; and authenticate to the NPN using the received credential.

According to a seventeenth aspect, there is provided a vehicle server. The vehicle server is configured to: send, to a second server of a service provider, a request for network information relating to a non-public network, NPN, that is to be used by the service provider to provide a service to a vehicle; receive, from the second server, network information comprising a network identity of the NPN and a credential for the NPN; and send, to the vehicle, the received network information for the NPN for use by the vehicle to connect to, and authenticate with, the NPN.

According to an eighteenth aspect, there is provided a second server. The second server is configured to: receive, from a vehicle server, a request for network information relating to a non-public network, NPN, that is to be used by a service provider to provide a service to a vehicle; and send, to the vehicle server, the network information for the NPN, wherein the network information comprises a network identity and credential for the NPN.

According to a nineteenth aspect, there is provided a vehicle. The vehicle comprises: at least one processor, and a memory containing program code executable by the at least one processor, whereby execution of the program code by the at least one processor causes the vehicle to perform a method according to the twelfth aspect, or any embodiment thereof.

According to a twentieth aspect, there is provided a vehicle server. The vehicle server comprises: at least one processor, and a memory containing program code executable by the at least one processor, whereby execution of the program code by the at least one processor causes the vehicle server to perform a method according to the thirteenth aspect, or any embodiment thereof.

According to a twenty-first aspect, there is provided a second server. The second server comprises: at least one processor, and a memory containing program code executable by the at least one processor, whereby execution of the program code by the at least one processor causes the second server to perform a method according to the fourteenth aspect, or any embodiment thereof.

According to a twenty-second aspect, there is provided a vehicle system comprising: a vehicle according to the sixteenth aspect, the nineteenth aspect, or any embodiments thereof; and a vehicle server according to the seventeenth aspect, the twentieth aspect, or any embodiment thereof.

### BRIEF DESCRIPTION OF THE DRAWINGS

Some of the embodiments contemplated herein will now be described more fully with reference to the accompanying drawings, in which:

FIG. 1 shows a communication system comprising a PLMN and a NPN;

FIG. 2 is an example of a communication system;

FIG. 3 is an example of a UE in accordance with some embodiments;

FIG. 4 is an example of a vehicle in accordance with some embodiments;

FIG. 5 is an example of a server in accordance with some embodiments;

FIG. 6 is an example of a vehicle server in accordance with some embodiments;

FIG. 7 is an example of a virtualization environment in accordance with some embodiments;

FIG. 8 is a signalling diagram illustrating credential retrieval and parking reservation in an AVP-based embodiment;

FIG. 9 is a signalling diagram illustrating connection to a parking vendor's NPN in an AVP-based embodiment;

FIG. 10 is a signalling diagram illustrating a request for and receipt of an AVP service in an AVP-based embodiment;

FIG. 11 is a signalling diagram illustrating an end of an AVP service in an AVP-based embodiment;

FIG. 12 is a flow chart illustrating a method of operating a wireless device according to an aspect;

FIG. 13 is a flow chart illustrating a method of operating a first server according to an aspect;

FIG. 14 is a flow chart illustrating a method of operating a second server according to an aspect;

FIG. 15 is a flow chart illustrating a method of operating a vehicle according to an aspect;

FIG. 16 is a flow chart illustrating a method of operating a vehicle server according to an aspect; and

FIG. 17 is a flow chart illustrating another method of operating a second server according to an aspect.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Briefly, the techniques described herein enable a wireless device that is connected to a public communication network to connect to a NPN to receive a service. In particular, the wireless device receives a credential and information about a NPN that it is to connect to, and from which the wireless device is to receive a service. The disclosed techniques are not limited to any particular type of service, and the service can be or comprise, for example, providing a private network for use by certain users (e.g. employees and/or equipment/machines in a factory; guests in a hotel, holiday park or conference centre, etc.), improving wireless device connectivity (e.g. Internet access) in a particular area or region where coverage from the public communication network may be poor (e.g. in a hotel, holiday park, conference centre, car park, a mine, etc.), or providing a vehicle-related service, such as providing digital map data (e.g. including a route and/or destination for the vehicle), autonomously parking the vehicle and/or autonomously driving the vehicle. Thus, an NPN and the associated service can be deployed in any desired location or area, such as: conference centres, hotels, holiday parks, factories, warehouses, depots, logistic hubs, car parks, airports, seaports, train stations, in a mine, etc. The described techniques provide a scalable and dynamic mechanism for a wireless device to transition to a NPN.

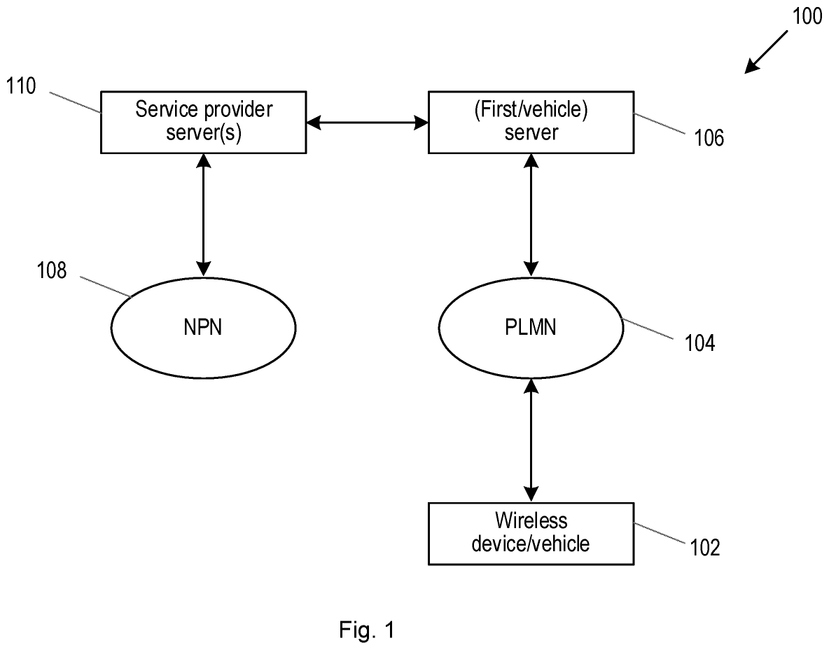

FIG. 1 illustrates a communication system 100 to which the techniques described herein can be applied. The communication system 100 includes a wireless device 102 that is connected to a public communication network 104, which is referred to herein as PLMN 104. The PLMN 104 may be the Home PLMN (HPLMN) of the wireless device 102, or a PLMN that the wireless device 102 is roaming in (i.e. the PLMN 104 is a visited PLMN (VPLMN)). The wireless device 102 is also referred to herein as a user equipment (UE). In other embodiments, wireless device functionality is incorporated into a vehicle, and the vehicle itself can be considered to be a wireless device 102. Unless otherwise indicated, references herein to a “wireless device” also include a vehicle that has wireless device functionality that enables the vehicle to connect to a public communication network.

The wireless device/vehicle 102 is associated with a server 106, which is referred to interchangeably herein as a “first server”, “application server”, “managing server” and “vehicle server”. The first server 106 uses the PLMN 104 (or other PLMN that the wireless device/vehicle 102 is connected to) to communicate with the wireless device/vehicle 102 (and vice versa). The first server 106 is associated with the wireless device/vehicle 102 and is trusted by the wireless device/vehicle 102. For example, the first server 106 can be operated by a manufacturer of the wireless device/vehicle 102, or, in the case of a vehicle, operated by a manager of a vehicle fleet of which the vehicle 102 is part. The wireless device 102 may be configured to communicate with the first server 106, or the wireless device 102 may comprise or be executing an application that is configured to communicate or interact with the application server 106.

In the case of the wireless device 102 being or being part of a vehicle, the vehicle server 106 can perform a number of functions or services with respect to the vehicle 102. For example any data communications to and from the vehicle 102, e.g. from/to an external network, and/or from/to a telematic control unit in the vehicle 102, will go via the vehicle server 106. The vehicle server 106 can be responsible for safe and secure data transfer between the vehicle 102 and any external networks or servers, e.g. NPN 108, service provider server(s) 110, etc. The vehicle server 106 may be able to access functions of the vehicle 102 remotely, for example locking/unlocking the vehicle 102, activating/deactivating an internal heating function, etc. and/or remotely control movement of the vehicle 102.

A provider of a service, for example a provider of a private network for a subset of users, or a provider of an automated vehicle service, such as providing digital map data (e.g. including a route and/or destination for the vehicle), parking the vehicle or a driving service, has deployed a NPN 108, and the service provider has one or more servers 110, denoted “service provider servers”. The one or more service provider servers 110 can perform different functions with respect to the service and/or wireless devices 102. The service provider server 110 is also referred to herein as a “second server”, “parking server”, and “parking application server”. One or more service provider servers 110 can be used to provide the service to wireless devices connected to the NPN 108. The wireless device 102 may be configured to communicate with the service provider server 110, or the wireless device 102 may comprise or be executing an application that is configured to communicate or interact with the service provider server 110. One or more of the service provider servers 110 can be configured to communicate with the first server 106, for example via the Internet or other communication network, to exchange information. In embodiments where the service provided is an automated vehicle parking or driving service, the NPN 108 can be deployed to cover an area where such a service is required, such as in a car parking garage/car park, in a logistic hub, at train stations, airports, seaports, in a mine, etc.

As known to those skilled in the art, NPNs can be deployed in a number of different ways. Two different ways are described in section 5.30 of 3GPP TS 23.501 “System architecture for the 5G System (5GS)”, which describes a Public Network Integrated-Non Public Network (PNI-NPN), and a Standalone NPN (SNPN). Thus, the NPN 108 can be deployed with a shared radio access network (RAN), where the RAN is used both by the NPN and the PLMN 104. The NPN 108 can alternatively share core network functions with the PLMN, but have a dedicated RAN, or it can be comprised of a shared RAN and shared core network functions. The sharing of the core functions can be achieved using slicing technology.

In accordance with the techniques described herein, a service provider server 110 can provide network information relating to the NPN 108 to the first server 106, and the first server 106 passes this network information to the wireless device 102. The network information indicates the identity of the NPN 108 and also a credential for the NPN 108 that the wireless device 102 can use to authenticate with the NPN 108. Thus, providing the network information to the wireless device 102 enables the wireless device 102 to access the NPN 108. Once the wireless device 102 has the network information, the occurrence of a trigger causes the wireless device 102 to search for the identified NPN 108, and if found, to connect to the NPN 108 using the credential in the network information, and during this process the UE may switch operation mode, e.g. change to a NPN access mode.

Thus, credential exchange is performed between the first server 106 and the service provider server 110, and the first server 106 provides the credential to the wireless device 102, without requiring any specific action by or interaction with the PLMN 104 or the operator of the PLMN 104. Furthermore, the trigger to start the search for the NPN 108 can be automatic (e.g. the trigger can be the wireless device 102 being at a particular location or the trigger can be provided by the first server 106 or the service provider server 110) or manual (e.g. the trigger can be provided by a user of the wireless device 102 requesting the service provided by the NPN 108).

Once the wireless device 102 is connected to the NPN 108, e.g. in the NPN access mode, the service provider server 110 may provide the service to the wireless device 102 directly via the NPN 108, or indirectly via the first server 106 and the NPN 108. Thus, in embodiments where the wireless device 102 is a vehicle and the service involves automated driving/parking of the vehicle, the service provider server 110 may be trusted by the first server 106 to control the vehicle movements, in which case the service provider server 110 can control the vehicle 102 via the NPN 108 and/or provide a digital map including a route and/or destination of the vehicle 102 via the NPN 108. Alternatively, the first server 106 may prefer to handle interactions between vehicles 102 and service provider server 110 via its own system, in which case the service provider server 110 can provide vehicle movement instructions to the first server 106, the first server 106 can evaluate/verify the movements, and the first server 106 can control the vehicle movements via the NPN 108.

As noted above, the techniques described herein involve credential exchange between the first server 106 and the service provider server 110, which means that the first server 106 is trusted by the service provider server 110. This trust relationship can be established and exist between the enterprise or other entity that owns and/or operates the first server 106 and the enterprise or other entity that provides the service in the NPN 108. The establishment of this relationship is outside the scope of this disclosure, but nevertheless those skilled in the art will be aware of various techniques for establishing trust between two servers, for example using a Public Key Infrastructure (PKI)-based approach.

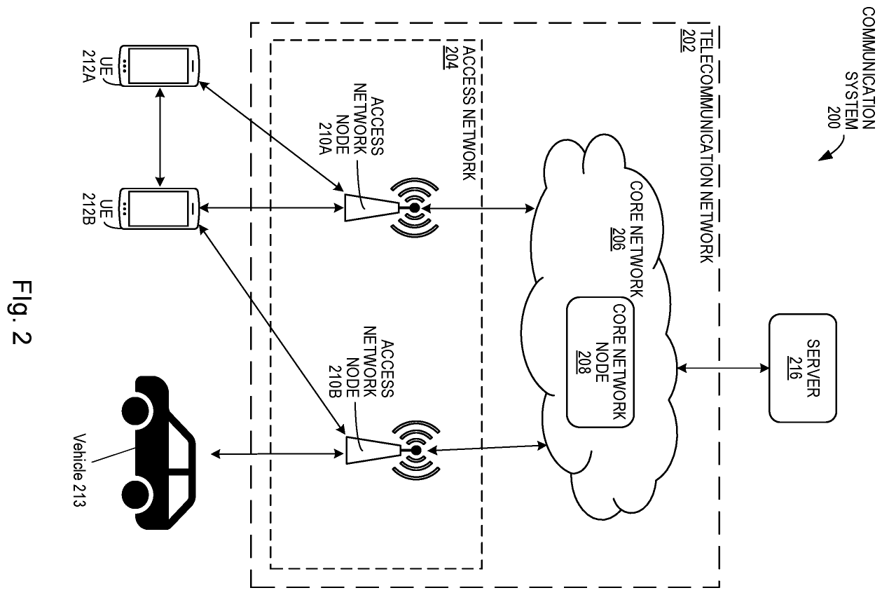

FIG. 2 shows an example of a communication system 200 in accordance with some embodiments.

In the example, the communication system 200 includes a telecommunication network 202 that includes an access network 204, such as a radio access network (RAN), and a core network 206, which includes one or more core network nodes 208. The PLMN 104 in FIG. 1 can be implemented in a similar way to telecommunication network 202. In embodiments where the NPN 108 is deployed as a fully standalone network, the NPN 108 in FIG. 1 can be implemented in a similar way to telecommunication network 202. In embodiments where the NPN 108 shares a core network with an existing PLMN, the NPN 108 can comprise an access network 204 as shown in FIG. 2. The NPN's access network 204 will connect to a core network 206 of another PLMN (although as noted above, this PLMN may be different to the PLMN 104). In some examples the NPN 108 is implemented as a network slice within an existing PLMN, and therefore the NPN 108 shares the access network 204 and the core network 206 with the PLMN 104.

The access network 204 includes one or more access network nodes, such as access network nodes 210a and 210b (one or more of which may be generally referred to as network nodes 210), or any other similar 3rd Generation Partnership Project (3GPP) access node or non-3GPP access point. The access network nodes 210 facilitate direct or indirect connection of wireless devices, such as by connecting user equipments (UEs) 212a and 212b (one or more of which may be generally referred to as UEs 212) and/or vehicle(s) 213, to the core network 206 over one or more wireless connections. Examples of access network nodes 210 include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. An access network node 210 may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of access network nodes 210 include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 200 may include any number of wired or wireless networks, network nodes, UEs, and/or any other components or systems that may facilitate or participate in the communication of data and/or signals whether via wired or wireless connections. The communication system 200 may include and/or interface with any type of communication, telecommunication, data, cellular, radio network, and/or other similar type of system.

The UEs 212 and/or vehicle 213 may be any of a wide variety of communication devices, including devices arranged, configured, and/or operable to communicate wirelessly with the access network nodes 210 and other communication devices. Similarly, the access network nodes 210 are arranged, capable, configured, and/or operable to communicate directly or indirectly with the UEs 212 and/or vehicle 213 and/or with other network nodes or equipment in the telecommunication network 202 to enable and/or provide network access, such as wireless network access, and/or to perform other functions, such as administration in the telecommunication network 202.

In the depicted example, the core network 206 connects the access network nodes 210 to one or more servers, such as server 216. The one or more servers 216 can include the first server 106 and/or service provider server(s) 110 shown in FIG. 1. The connections to the server(s) 216 may be direct or indirect via one or more intermediary networks or devices. In other examples, network nodes may be directly coupled to server(s) 216.

The core network 206 includes one more core network nodes (e.g., core network node 208) that are structured with hardware and software components. Features of these components may be substantially similar to those described with respect to the UEs, network nodes, and/or server(s), such that the descriptions thereof are generally applicable to the corresponding components of the core network node 208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The server(s) 216 may be under the ownership or control of a service provider other than an operator or provider of the access network 204 and/or the telecommunication network 202, and may be operated by the service provider or on behalf of the service provider. For example, a server 216 can be operated by a manufacturer or other trusted party of the UE 212 and/or vehicle 213. As another example, a server 216 can be operated by a provider of the service in the NPN 108. As another example, the service provider may be the same entity as, or a related entity to, the operator of the telecommunication network 202. In this example, the operator of the telecommunication network 202 may operate the NPN 108 to provide a particular service to some of its UEs 212 and/or vehicles 213. The server 216 may host a variety of applications to provide one or more services. Examples of such applications include the provision of live and/or pre-recorded audio/video content, control and/or monitoring of vehicle 213, for example for the purpose of AVP, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 200 of FIG. 2 enables connectivity between the UEs, vehicles, network nodes, and servers. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, including cellular vehicle-to-everything (C-V2X), or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 202 is a cellular network that implements 3GPP standardized features. Accordingly, the telecommunications network 202 may support network slicing to provide different logical networks to different devices that are connected to the telecommunication network 202. For example, the telecommunications network 202 may provide Ultra Reliable Low Latency Communication (URLLC) services to some wireless devices, while providing Enhanced Mobile Broadband (eMBB) services to other wireless devices, and/or Massive Machine Type Communication (mMTC)/Massive IoT services to yet further wireless devices.

In some examples, the UEs 212 and/or vehicle(s) 213 are configured to transmit and/or receive information without direct human interaction. For instance, a UE/vehicle may be designed to transmit information to the access network 204 on a predetermined schedule, when triggered by an internal or external event, or in response to requests from the access network 204. Additionally, a UE/vehicle may be configured for operating in single- or multi-RAT or multi-standard mode. For example, a UE/vehicle may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

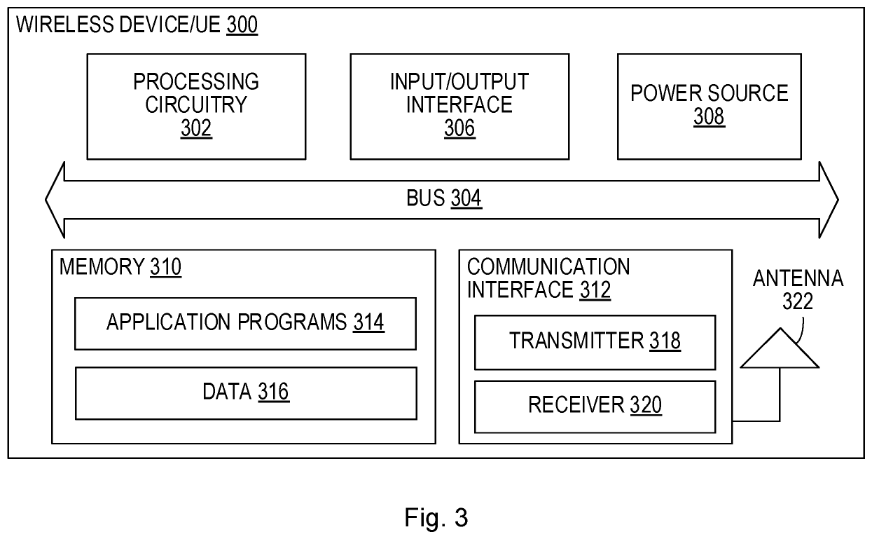

FIG. 3 shows a wireless device/UE 300 in accordance with some embodiments. As used herein, a wireless device/UE refers to a device capable, configured, arranged and/or operable to communicate wirelessly with network nodes and/or other UEs. Examples of a wireless device/UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 300 includes processing circuitry 302 that is operatively coupled via a bus 304 to an input/output interface 306, a power source 308, a memory 310, a communication interface 312, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

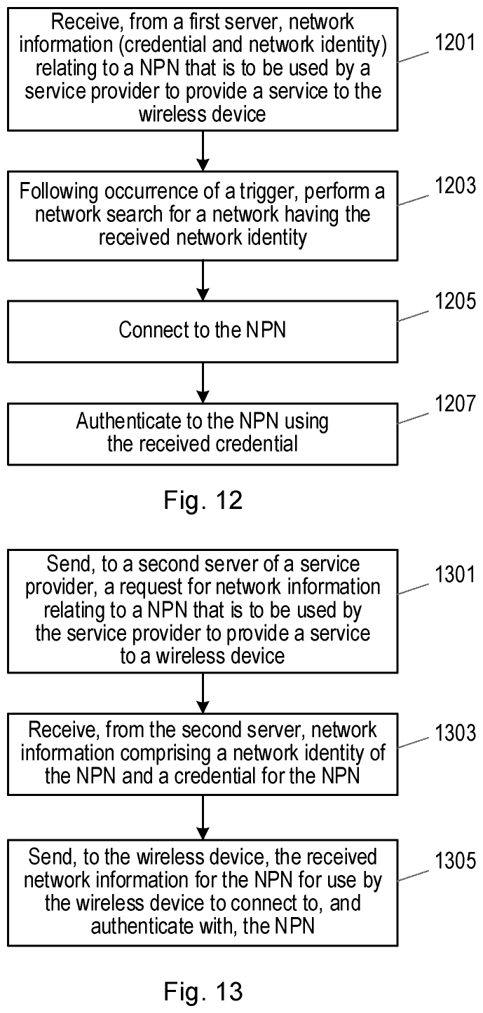

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 302 may include multiple central processing units (CPUs). The processing circuitry 302 may be operable to provide, either alone or in conjunction with other UE 300 components, such as the memory 310, UE 300 functionality. For example, the processing circuitry 302 may be configured to cause the UE 302 to perform the methods as described with reference to FIG. 12.

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the UE 300 via input circuitry or an interface such as an electrical power cable. Delivering power may be, for example, for charging of the power source 308. Power circuitry may perform any formatting, converting, or other modification to the power from the power source 308 to make the power suitable for the respective components of the UE 300 to which power is supplied.

The memory 310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the UE 300, any of a variety of various operating systems or combinations of operating systems.

The memory 310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card’. The memory 310 may allow the UE 300 to access instructions, application programs and the like, stored on transitory or non-transitory memory media, to off-load data, or to upload data. An article of manufacture, such as one utilizing a communication system may be tangibly embodied as or in the memory 310, which may be or comprise a device-readable storage medium.

The processing circuitry 302 may be configured to communicate with an access network or other network using the communication interface 312. The communication interface 312 may comprise one or more communication subsystems and may include or be communicatively coupled to an antenna 322. The communication interface 312 may include one or more transceivers used to communicate, such as by communicating with one or more remote transceivers of another device capable of wireless communication (e.g., another UE or a network node in an access network). Each transceiver may include a transmitter 318 and/or a receiver 320 appropriate to provide network communications (e.g., optical, electrical, frequency allocations, and so forth). Moreover, the transmitter 318 and receiver 320 may be coupled to one or more antennas (e.g., antenna 322) and may share circuit components, software or firmware, or alternatively be implemented separately.

In some embodiments, communication functions of the communication interface 312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 300 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

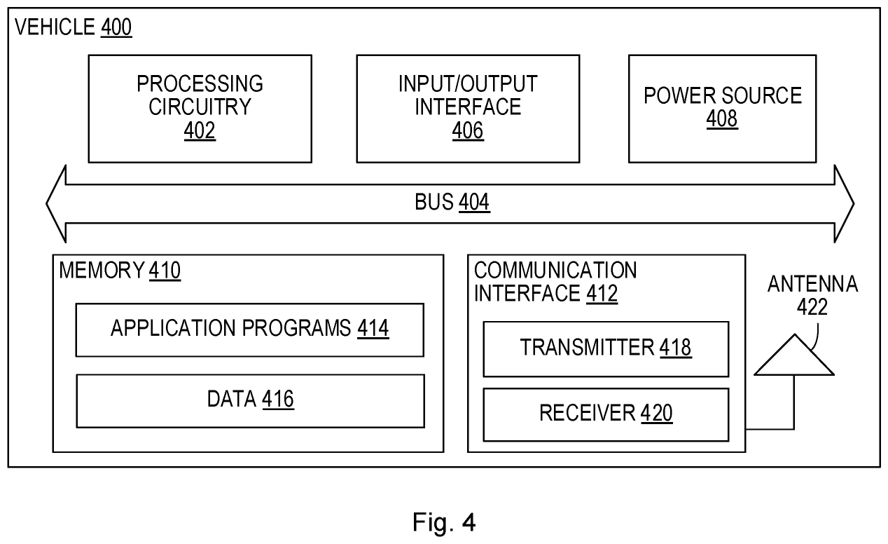

FIG. 4 shows a vehicle 400 in accordance with some embodiments. As used herein, vehicle 400 refers to any vehicle capable, configured, arranged and/or operable to communicate wirelessly with network nodes, UEs and/or other vehicles 400. Examples of a vehicle include, but are not limited to, a motorbike, a car, a bus, a coach, a farm vehicle, an industrial vehicle. One or more of the components of the vehicle 400 shown in FIG. 4 can be implemented in a telematic control unit (TCU) of the vehicle 400, in an electronic control unit (ECU) of the vehicle 400, or in an on-board unit (OBU) of the vehicle 400.

A vehicle 400 may support D2D communication, for example by implementing a 3GPP standard for sidelink communication, DSRC, V2V, V2I, or V2X.

The vehicle 400 includes processing circuitry 402 that is operatively coupled via a bus 404 to an input/output interface 406, a power source 408, a memory 410, a communication interface 412, and/or any other component, or any combination thereof. Certain vehicles may utilize all or a subset of the components shown in FIG. 4. The level of integration between the components may vary from one vehicle to another vehicle. Further, certain vehicles may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, FPGAS, ASICs, etc.); programmable logic together with appropriate firmware; one or more stored computer programs, general-purpose processors, such as a microprocessor or DSP, together with appropriate software; or any combination of the above. For example, the processing circuitry 402 may include multiple CPUs. The processing circuitry 402 may be operable to provide, either alone or in conjunction with other vehicle 400 components, such as the memory 410, vehicle 400 functionality. For example, the processing circuitry 402 may be configured to cause the vehicle 400 to perform the methods as described with reference to FIG. 15.

In the example, the input/output interface 406 may be configured to provide an interface or interfaces to an input device, output device, or one or more input and/or output devices. Examples of an output device include a speaker, a display, a monitor, an actuator, an emitter, another output device, or any combination thereof. An input device may allow information to be captured into the vehicle 400. Examples of an input device include a touch-sensitive or presence-sensitive display, a camera (e.g., a digital camera, a digital video camera, etc.), a microphone, an accelerometer, a gyroscope, a tilt sensor, a force sensor, a magnetometer, an optical sensor, a proximity sensor, a biometric sensor, a proximity sensor (e.g. parking sensor), an environmental (weather) sensor, a sensor of an operating parameter of a vehicle engine, a sensor of an operating parameter of a vehicle battery, a sensor of an operating parameter of a vehicle electric motor, and the like. The presence-sensitive display may include a capacitive or resistive touch sensor to sense input from a user. An output device may use the same type of interface port as an input device. For example, a USB port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 308 itself, and/or an external power source, to the various parts of the vehicle 400 via input circuitry or an interface such as an electrical power cable. Delivering power may be, for example, for charging of the power source 408. Power circuitry may perform any formatting, converting, or other modification to the power from the power source 408 to make the power suitable for the respective components of the vehicle 400 to which power is supplied.

The memory 410 may be or be configured to include memory such as RAM, ROM, PROM, EPROM, EEPROM, magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the vehicle 400, any of a variety of various operating systems or combinations of operating systems.

The memory 410 may be configured to include a number of physical drive units, such as RAID, flash memory, USB flash drive, external hard disk drive, thumb drive, pen drive, key drive, HD-DVD optical disc drive, internal hard disk drive, Blu-Ray optical disc drive, HDDS optical disc drive, external mini-DIMM, SDRAM, external micro-DIMM SDRAM, smartcard memory such as tamper resistant module in the form of a UICC including one or more SIMs, such as a USIM and/or ISIM, other memory, or any combination thereof. The UICC may for example be an eUICC, iUICC or a removable UICC. The memory 410 may allow the vehicle 400 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another vehicle, a UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In some embodiments, communication functions of the communication interface 412 may include cellular communication, Wi-Fi communication, LPWAN communication, data communication, voice communication, multimedia communication, short-range communications such as Bluetooth, near-field communication, location-based communication such as the use of the GPS to determine a location, another like communication function, or any combination thereof. Communications may be implemented in according to one or more communication protocols and/or standards, such as IEEE 802.11, CDMA, WCDMA, GSM, LTE, New Radio (NR), UMTS, WiMax, Ethernet, TCP/IP, SONET, ATM, QUIC, HTTP, and so forth.

Regardless of the type of sensor or input device, a vehicle 400 may provide an output of data captured by its sensors, through its communication interface 412, via a wireless connection to a network node. Data captured by sensors of a vehicle 400 can be communicated through a wireless connection to a network node via another vehicle or a UE. The output may be periodic, random, in response to a triggering event, in response to a request, or a continuous stream.

As another example, a vehicle 400 comprises an actuator (e.g. an engine) or an electric motor related to a communication interface configured to receive wireless input from a network node via a wireless connection. In response to the received wireless input the states of the actuator and/or the electric motor may change.

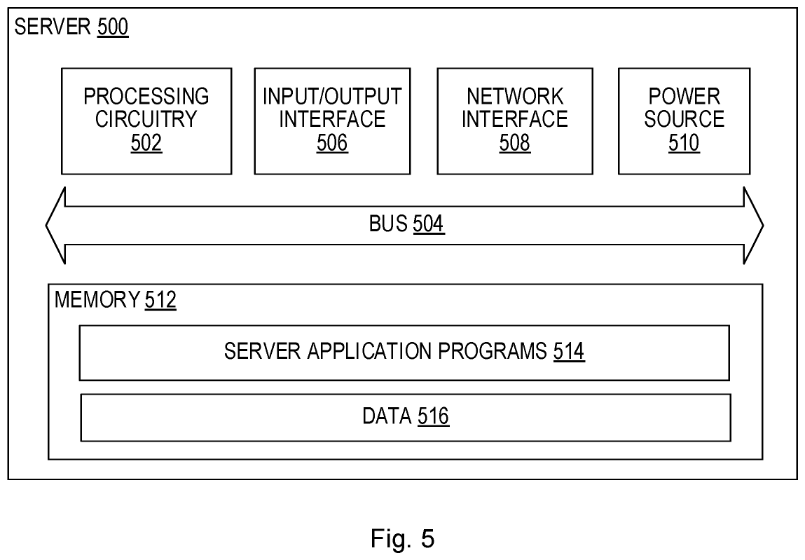

FIG. 5 is a block diagram of a server 500, which may be an embodiment of the server 216 of FIG. 2, the first server/vehicle server 106 of FIG. 1 and/or the second server/service provider server 110 of FIG. 1, in accordance with various aspects described herein. As used herein, the server 500 may be or comprise various combinations hardware and/or software, including a standalone server, a blade server, a cloud-implemented server, a distributed server, a virtual machine, container, or processing resources in a server farm. The server 500 may provide one or more services to one or more wireless devices, UEs and/or vehicles.

The server 500 includes processing circuitry 502 that is operatively coupled via a bus 504 to an input/output interface 506, a network interface 508, a power source 510, and a memory 512. Other components may be included in other embodiments. Features of these components may be substantially similar to those described with respect to the devices of previous figures, such as FIGS. 3 and 4, such that the descriptions thereof are generally applicable to the corresponding components of server 500.

The memory 512 may include one or more computer programs including one or more server application programs 514 and data 516, which may include user data, e.g., data generated by a UE or vehicle for the server 500 or data generated by the server 500 for a UE or vehicle. Embodiments of the server 500 may utilize only a subset or all of the components shown. The server application programs 514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The server application programs 514 may also provide for user authentication and licensing checks and may periodically report health, routes, and content availability to a central node, such as a device in or on the edge of a core network.

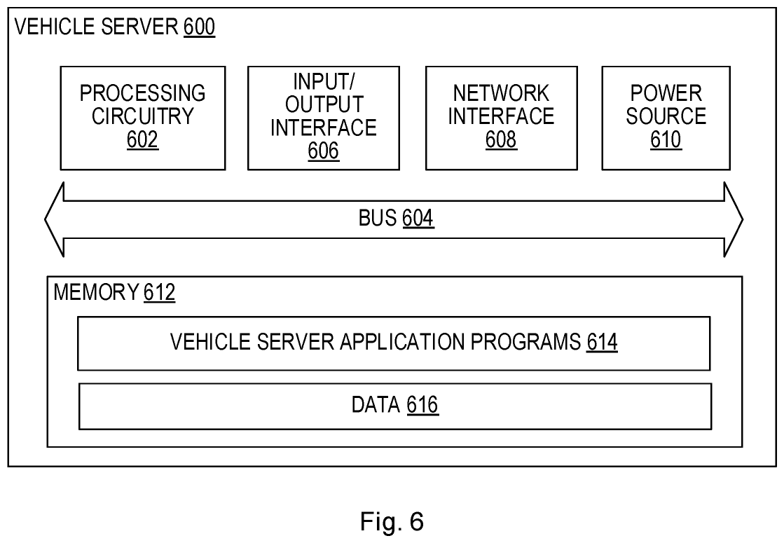

FIG. 6 is a block diagram of a vehicle server 600, which may be an embodiment of the server 216 in FIG. 2, an embodiment of the server 500 in FIG. 5, or the vehicle server 106 in FIG. 1. As used herein, the vehicle server 600 may be or comprise various combinations hardware and/or software, including a standalone server, a blade server, a cloud-implemented server, a distributed server, a virtual machine, container, or processing resources in a server farm. The vehicle server 600 may provide one or more services to one or more vehicles. The services can include any of: providing digital map data (including a route and/or destination for the vehicle, such as a parking space), traffic data, software updates, telematic data exchange, remote locking/unlocking of the vehicle, activating/deactivating a heating/cooling function, etc.

The vehicle server 600 includes processing circuitry 602 that is operatively coupled via a bus 604 to an input/output interface 606, a network interface 608, a power source 610, and a memory 612. Other components may be included in other embodiments. Features of these components may be substantially similar to those described with respect to the devices of previous figures, such as FIGS. 3, 4 and 5, such that the descriptions thereof are generally applicable to the corresponding components of vehicle server 600.

The memory 612 may include one or more computer programs including one or more vehicle server application programs 614 and data 616, which may include user data, e.g., data generated by a vehicle (for example vehicle 213 in FIG. 2) for the vehicle server 600 or data generated by the vehicle server 600 for a vehicle (for example vehicle 213 in FIG. 2). Embodiments of the vehicle server 600 may utilize only a subset or all of the components shown. The vehicle server application programs 614 may be implemented in a container-based architecture and may provide support for the various services (e.g. map data, traffic data, telematics, etc.) provided by the vehicle server 600 to vehicles. The vehicle server application programs 614 may also provide for user authentication and licensing checks and may periodically report health, routes, and content availability to a central node, such as a device in or on the edge of a core network.

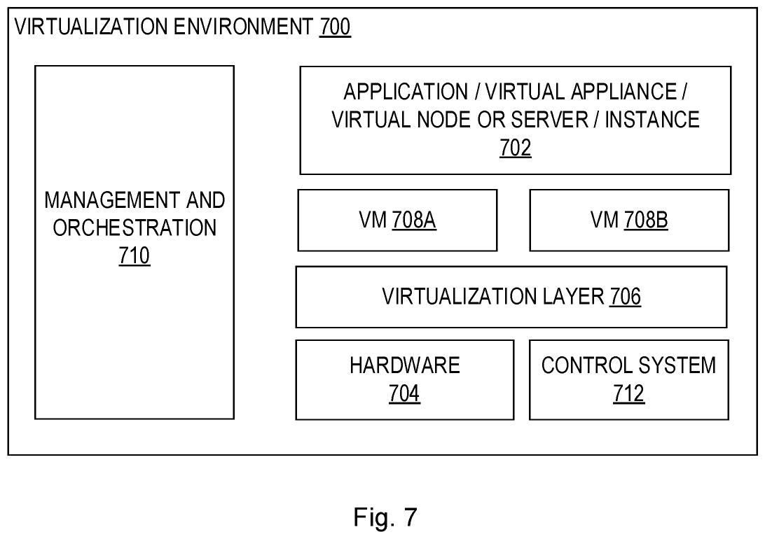

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. As such, virtualization can be applied to any of a UE, a vehicle, a first server, a vehicle server, a service provider server, or a network node. Some or all of the functions described herein may be implemented as virtual components executed by one or more virtual machines (VMs) implemented in one or more virtual environments 700 hosted by one or more of hardware nodes, such as a hardware computing device that operates as a network node, UE, vehicle, core network node, server, or vehicle server. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node or server with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 712 which may alternatively be used for communication between hardware nodes and radio units.

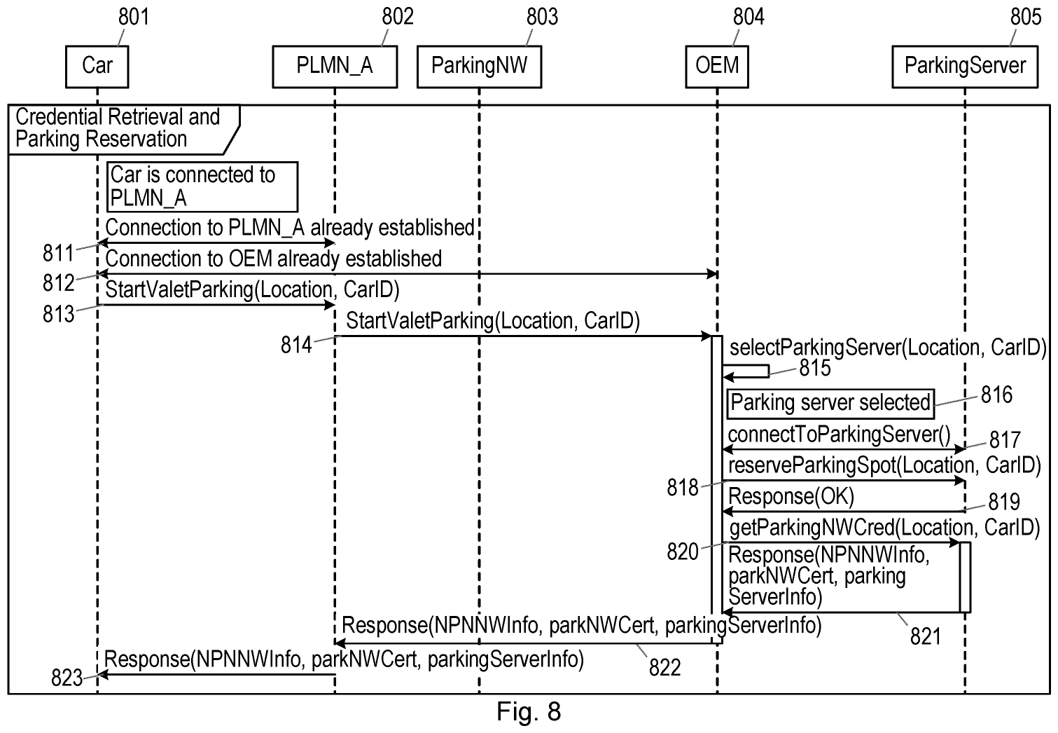

The signalling diagrams in FIGS. 8-11 illustrate the use of the techniques described herein for providing an AVP service to a car. FIGS. 8-11 show the signalling between a wireless device in the form of a car 801, a public communication network PLMN_A 802, a NPN 803 that is named ‘ParkingNW’, a first server 804 labelled ‘OEM’ that is managed by the manufacturer of the car 801, and a service provider server 805 that is labelled ‘ParkingServer’. The ParkingServer 805 may represent a single server, or multiple servers operated by the service provider. For example, one ParkingServer 805 may be responsible for providing the network information for the ParkingNW 803 to the car 801, and another ParkingServer 805 may be responsible for providing the service itself to the car 801.

FIG. 8 is a signalling diagram illustrating a credential retrieval and parking reservation part of an AVP process. Initially, the car 801 is connected to PLMN_A 802 (indicated by signal 811) and the car 801 and the OEM server 804 use the PLMN_A 802 to communicate with each other (as indicated by signal 812).

A driver in the car 801 or a remote operator/dispatcher of the car 801 can indicate the need for a parking service in the near future using a parking application installed in the car 801 or in the user's smartphone or other device. Alternatively, the need for a parking service can be determined from information about the intended route of the car 801 indicating that the route ends at a car park. The information about the intended route of the car 801 can be obtained, for example, from a satellite navigation system in the car 801. A request for the parking service can be indicated to the OEM server 804 by the car 801 via the PLMN_A 802, as shown by signals 813 and 814. The request for the parking service can include an identifier for the car 801 (‘CarID’) and an indication of the location at which the parking service will be required.

The OEM server 804 selects an appropriate parking server 805 for the parking service based on the location at which the parking service will be required (steps 815 and 816) and sets up a connection to the selected ParkingServer 805 (signal 817). The selected ParkingServer 805 may be a server that serves multiple car parks (e.g. owned and/or operated by the same enterprise), or a server specific to the particular car park that the car 801 is heading to.

The OEM server 804 reserves a parking space for the car 801 (signal 818), and can provide the identifier of the car 801 (CarID) and optionally the location at which the parking service will be required to the ParkingServer 805. The ParkingServer 805 reserves the parking space for the car 801 and acknowledges the request from the OEM server 804 (signal 819).

Next, the OEM server 804 requests the network information that the car 801 requires in order to connect to the ParkingNW 803. Thus the OEM server 804 sends a ‘getParkingNWCred’ message 820 to the ParkingServer 805. The message 820 can indicate the identifier of the car 801 and the location at which the parking service is required.

The ParkingServer 805 responds to the request by sending the appropriate network information to the OEM server 804. The response is shown as signal 821, and the response can include the identity of the ParkingNW 803, the credential for the ParkingNW 803 (denoted ‘parkNWCert’) and the identity of the ParkingServer 805 (denoted ‘parkingServerInfo’). The credential may be a public key infrastructure (PKI) certificate. The identity of the ParkingServer 805 may provide information for enabling the car 801 to connect to the ParkingServer 805. Thus, the identity of the ParkingServer 805 can be in the form of an Internet Protocol (IP) address, a uniform resource locator (URL), or similar. The response 821 may also include frequency information for the ParkingNW 803, for example indicating one or more frequencies or frequency bands used by the ParkingNW 803. The frequency information can be in the form of an absolute radio-frequency channel number (ARFCN).

In some cases, the OEM server 804 may already have the network information available for the ParkingNW 803, for example from previous use of the parking service for the car 802 or another vehicle operated or managed by the OEM server 804. Thus, prior to sending message 820, the OEM server 804 can determine if it has the appropriate network information available, for example the identity of the ParkingNW 803 and a credential for use by the car 801 in authenticating to the ParkingNW 803 (and optionally also the frequency/frequency band information). If the OEM server 804 has the network information available, the request 820 and response 821 may not be required.

The OEM server 804 forwards the received network information relating to the ParkingNW 803 and ParkingServer 805 to the car 801 via the PLMN_A 802, as shown by signals 822 and 823.

The car 801 now has the information required to access the ParkingNW 803 when a parking service is required.

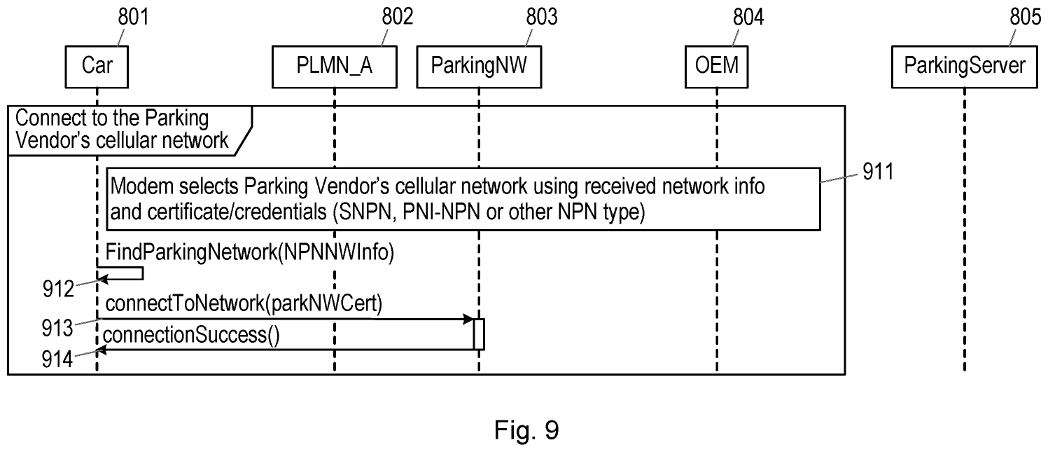

The signalling diagram in FIG. 9 illustrates the connection of the car 801 to the ParkingNW 803. When the car 801 arrives at or is close to the designated car park after having received a confirmation that an AVP service request for the car park has been made and accepted, and having received the required network information from the OEM server 804, the car 801, or a parking application in the car 801 activates the access method used by the NPN (e.g. in the case of a Standalone NPN, the SNPN access mode as specified in the 3GPP standards), and initiates a search for the ParkingNW 803 according to the received network information (steps 911 and 912). Thus, the radio circuitry in the car 801 searches for a network having the identity of the ParkingNW 803 on the indicated frequency/ies/frequency band. The parking application in the car 801 can for example provide AT commands to the radio circuitry to tune the radio circuitry to the appropriate frequency band/ARFCN, or use other means to tune the radio, for example an application programming interface (API) may be provided by the used Operating System (OS). The trigger for the car 801 to start searching for the ParkingNW 803 can be any of: the car 801 arriving at a particular location or being close to a particular location (e.g. arriving at the car park or a drop-off bay of the car park, or being close to the car park), a user of the car 801 requesting the start of the parking service, or the OEM server 804 requesting the start of the parking service. The location of the car 801 can be determined from location/position information output from the satellite navigation system of the car 801, route information output from the satellite navigation system, and/or from one or more cameras located near to or in the car park that identify vehicles using, for example, automated number plate recognition (ANPR) algorithms.

If the ParkingNW 803 is detected by the car 801, the car 801 sends a connection request 913 to the ParkingNW 803 to request connection to the ParkingNW 803. The car 801 can send the credential (parkNWCert) for the ParkingNW 803 with the connection request 913 to effect authentication of the car 801 to the ParkingNW 803.

If the ParkingNW 803 accepts the authentication of the car 801, the ParkingNW 803 can accept the connection request and establish the connection with the car 801 (indicated by signal 914).

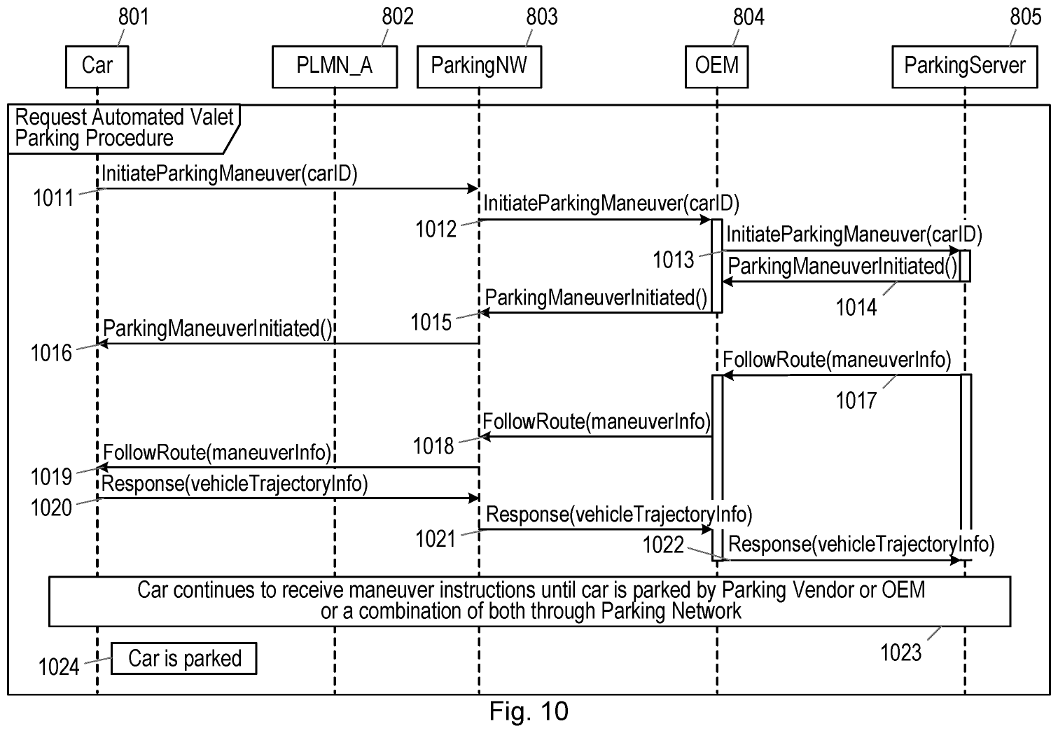

The signalling diagram in FIG. 10 illustrates the request for and receipt of the AVP service by the car 801. In this implementation, the movement instructions or commands for the car 801 are provided from the ParkingServer 805 to the car 801 via the OEM server 804, as the OEM server 804 prefers to control the movement of the car 801 on behalf of the AVP service. However, as noted above in other implementations the car 801 can communicate directly with the ParkingServer 805 via the ParkingNW 803, i.e. without the communications passing via the OEM server 804. These other implementations can include the ParkingServer 805 providing digital map data to the car 801 via the ParkingNW 803, with the digital map data indicating the route and/or destination parking space for the car 801. In this case, the car 801 can use the provided digital map data to autonomously drive to the indicated parking space.

The car 801 or application in the car 801 requests the parking manoeuvre is initiated by sending a request to the OEM server 804 via the ParkingNW 803 (signals 1011 and 1012). The request 1011/1012 can include the identifier of the car 801.

The OEM server 804 forwards the request to the ParkingServer 805 (signal 1013), and the ParkingServer 805 confirms to the OEM server 804 that the parking manoeuvre will be initiated (signal 1014). The OEM server 804 forwards the confirmation that the parking manoeuvre will be initiated to the car 801 via the ParkingNW 803 (signals 1015 and 1016). Signals 1011 to 1016 effect the connection of the parking application in the car 801 to the ParkingServer 805. As noted above, the ParkingServer 805 may be the same or a different entity to the ParkingServer 805 that provided the network information via signal 821.

After initiating the parking manoeuvre, the ParkingServer 805 determines the first movement the car 801 needs to perform and sends an appropriate movement instruction to the car 801 via the OEM server 804, which can verify or approve the movement instruction before forwarding it to the car 801 via the ParkingNW 803. This movement instruction is shown by ‘FollowRoute’ signal 1017 from the ParkingServer 805 to the OEM server 804, and the ‘FollowRoute’ signals 1018 and 1019 from the OEM server 804 to the car 801 via the ParkingNW 803.

The car 801 can implement the movement instruction (i.e. the car 801 moves according to the instruction) and provides a response 1020 to the ParkingServer 805. The response 1020 can indicate current information about the car's position and trajectory (i.e. direction of movement and speed). The response is sent to the ParkingServer 805 via the ParkingNW 803 and OEM server 804, as indicated by signals 1020, 1021 and 1022.

The procedure represented by signals 1017 to 1022 is repeated (step 1023) until the car 801 is parked in the appropriate parking space (step 1024).

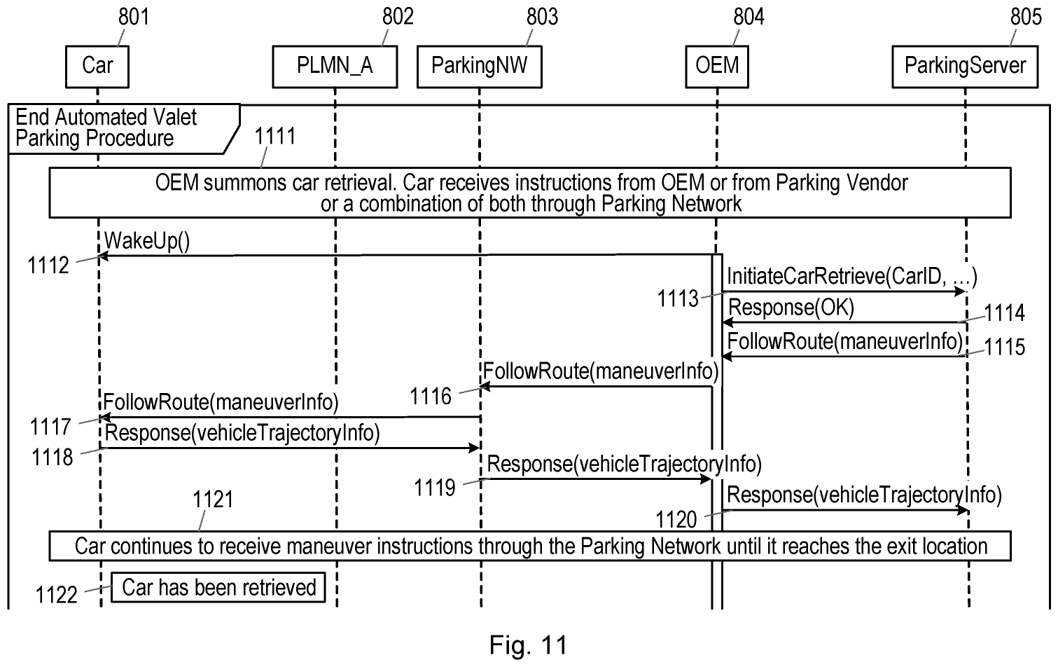

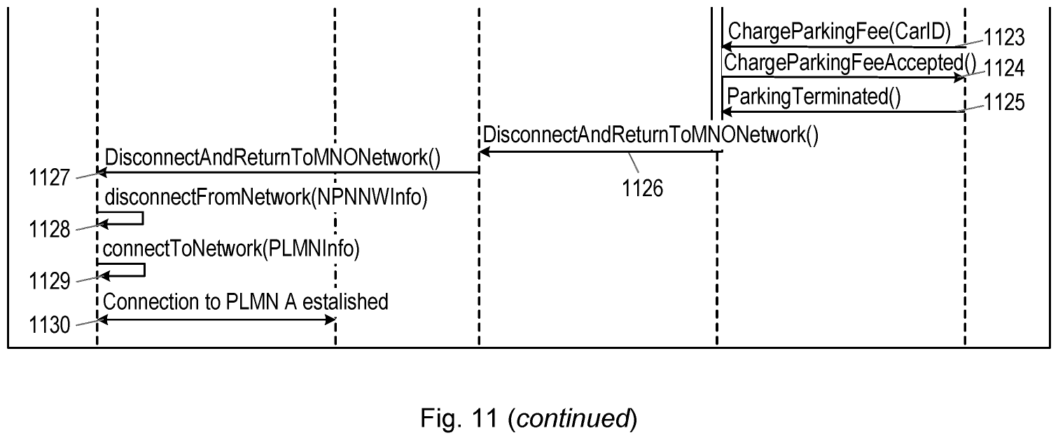

The signalling diagram in FIG. 11 illustrates the end of the provision of the AVP service. This signalling diagram represents the car 801 being retrieved from the car park (step 1111), the AVP process being completed, and the car 801 returning to use the PLMN_A 802.

Thus, in step 1111 the OEM server 804 determines that the car 801 needs to be retrieved from the parking space, and the OEM server 804 sends a ‘wake up’ signal 1112 to the car 801 via the ParkingNW 803, and the OEM server 804 sends a car retrieval request 1113 to the ParkingServer 805.

The ParkingServer 805 acknowledges the request from the OEM server 804 with acknowledgement 1114.

The ParkingServer 805 determines the first movement the car 801 needs to perform to be retrieved from the parking space and sends an appropriate movement instruction to the car 801 via the OEM server 804, which can verify or approve the movement instruction before forwarding it to the car 801 via the ParkingNW 803. This movement instruction is shown by ‘FollowRoute’ signal 1115 from the ParkingServer 805 to the OEM server 804, and the ‘FollowRoute’ signals 1116 and 1117 from the OEM server 804 to the car 801 via the ParkingNW 803.

The car 801 can implement the movement instruction (i.e. the car 801 moves according to the instruction) and provides a response 1118 to the ParkingServer 805. The response 1118 can indicate current information about the car's position and trajectory (i.e. direction of movement and speed). The response is sent to the ParkingServer 805 via the ParkingNW 803 and OEM server 804, as indicated by signals 1118, 1119 and 1120.

The procedure represented by signals 1115 to 1120 is repeated (step 1021) until the car 801 is fully retrieved from the parking space (step 1122), for example the car 801 has been returned to a customer pick-up location. The procedure represented by signals 1115 to 1120 is similar to that represented by signals 1017 to 1022.

Next, in optional steps 1123 and 1124, a business transaction can be completed between the OEM server 804 and the ParkingServer 805 relating to the provision of the parking service. Thus, the ParkingServer 805 can indicate a charge or fee for the car 801 to the OEM server 804, as indicated by signal 1123, and the OEM server 804 can indicate with signal 1124 that the charge or fee is accepted.

The ParkingServer 805 can terminate the provision of the parking service by indicating the termination of the parking service to the OEM server 804 via signal 1125.

The OEM server 804 can then instruct the car 801 to disconnect from the ParkingNW 803 and reconnect to the PLMN_A 802, or other public communication network available to the car 801 at the current location. Thus, the OEM server 804 can send a ‘disconnect and return’ signal 1126/1127 to the car 801 via the ParkingNW 803. In response to receiving the ‘disconnect and return’ signal 1127 the car 801 disconnects from the ParkingNW 803 (step 1128) and connects to PLMN_A 802 (step 1129). Step 1129 can be performed as a conventional ‘home network’ search. Thus, in step 1129 the radio circuitry in the car 801 searches for a network having the identity of the PLMN_A 802 or other public communication network, and connects to the PLMN. Optionally this search and reconnect may be optimized using a stored or an indicated frequency/ies/frequency band. The parking application in the car 801 can use APIs or provide AT commands to the radio circuitry to tune the radio circuitry to the appropriate frequency band/ARFCN for the PLMN_A 802. Finally, in step 1130, the car 801 reconnects to the PLMN_A 802. The OEM server 804 is subsequently able to communicate with the car 801 (and vice versa) via PLMN_A 802.

FIG. 12 is a flow chart illustrating a method according to various embodiments performed by a wireless device. The wireless device may perform the method in response to executing suitably formulated computer readable code. The computer readable code may be embodied or stored on a computer readable medium, such as a memory chip, optical disc, or other storage medium. The computer readable medium may be part of a computer program product.

At the start of the method, the wireless device 102 is connected to a public communication network 104. The wireless device 102 may be a UE. The wireless device 102 may be, or be part of, a vehicle.

In step 1201, the wireless device 102 receives, from the first server 106, network information relating to a NPN 108 that is to be used by a service provider to provide a service to the wireless device 102. The network information comprises at least a network identity of the NPN and a credential for the NPN. The first server 106 is a server that is trusted by the wireless device 102, for example the first server 106 can be a managing server that is operated by the manufacturer of the wireless device 102, or operated by a fleet operator in embodiments where the wireless device 102 is, or is part of, a vehicle.

The service provided by the service provider may be an autonomous parking service for the wireless device/vehicle 102, and/or a service for autonomous driving of the wireless device/vehicle 102.

In some embodiments, the public communication network 104 and the NPN 108 are operated by different network operators.

In some embodiments, the credential is unique to the wireless device 102. In some embodiments, the credential is unique to the service session (i.e. the session to be used to provide a specific instance of the service to the wireless device 102). In other embodiments, a group of wireless devices 102 (or all wireless devices 102) may share a single credential.

The credential may be of any suitable type, i.e. suitable for authenticating a wireless device 102 with the NPN 108. Authentication procedures that can be used to authenticate a wireless device 102 to the NPN 108 can include any of, an Extensible Authentication Protocol (EAP)-based procedure, a Certificate-based EAP-Transport Layer Security (EAP-TLS) procedure, and a username and password-based approach. The credential itself can be, for example, a username/password, a certificate, a PKI certificate, a public key, an access token, a subscriber profile (e.g. SIM profile), etc. In the latter case, the subscriber profile can be used where the operator of the PLMN_A 802 also manages/operates the ParkingNW 803 or other PNI-NPN as part of its network (i.e. with a shared RAN and shared core).

In some embodiments, the network information relating to the NPN 108 also comprises frequency information indicating one or more frequencies used by the NPN 108. The frequency information can be an ARFCN.

In some embodiments, the wireless device 102 can also receive server information from the first server 106. The server information indicates or identifies a second server 110 associated with the service provider that is to provide the service to the wireless device 102. The server information can be an IP address for the second server 110, a URL for the second server 110, or some other identifier for the second server 110.

In step 1203, which occurs following the occurrence of a trigger, the wireless device 102 performs a network search for a network having the received network identity (i.e. the wireless device 102 searches for NPN 108). Step 1203 can be considered to involve the wireless device 102 switching into a ‘NPN access mode’ where the wireless device 102 aims to connect to a NPN rather than a public communication network. In embodiments where the network information includes frequency information for the NPN 108, the network search can be performed on the one or more frequencies.

The trigger may be a request or input by a user of the wireless device 102 to use the service. The trigger may also or alternatively be the wireless device 102 being located at, within a predetermined distance of, or heading towards, a predetermined location (e.g. a car park). The trigger may also or alternatively be the receipt, via the public communication network 104, of an instruction or command to use the service from the first server 106.

In step 1205, the wireless device 102 connects to the NPN 108, and in step 1207 the wireless device 102 authenticates to the NPN 108 using the received credential.

In some embodiments, the wireless device 102 can then use the service via the NPN 108. In some embodiments, using the service comprises receiving data, instructions and/or commands from the first server 106 via the NPN 108. In alternative embodiments, using the service comprises receiving data, instructions and/or commands from the second server 110 via the NPN 108.

In some embodiments, the wireless device 102 can receive a disconnect notification indicating that the wireless device 102 is to reconnect to the public communication network 104. In this case, the wireless device 102 can disconnect from the NPN 108, perform a network search for the public communication network 104, and reconnect to the public communication network 104. The disconnect notification can be received via the NPN 108 from one of the first server 106, the second server 110 and another server associated with the service provider.

FIG. 13 is a flow chart illustrating a method according to various embodiments performed by a first server. The first server may perform the method in response to executing suitably formulated computer readable code. The computer readable code may be embodied or stored on a computer readable medium, such as a memory chip, optical disc, or other storage medium. The computer readable medium may be part of a computer program product.

In step 1301 the first server 106 sends a request for network information relating to a NPN that is to be used by a service provider to provide a service to a wireless device 102. The request is sent to a second server 110 of the service provider. The wireless device 102 may be a UE. The wireless device 102 may be, or be part of, a vehicle.

The service provided by the service provider may be an autonomous parking service for the wireless device/vehicle 102, and/or a service for autonomous driving of the wireless device/vehicle 102. In step 1303, the first server 106 receives network information from the second server 110. The network information comprises at least a network identity of the NPN and a credential for the NPN.

In some embodiments, the credential is unique to the wireless device 102. In some embodiments, the credential is unique to the service session (i.e. the session to be used to provide a specific instance of the service to the wireless device 102). In other embodiments, a group of wireless devices 102 (or all wireless devices 102) may share a single credential.

The credential may be of any suitable type, i.e. suitable for authenticating a wireless device 102 with the NPN 108. Authentication procedures that can be used to authenticate a wireless device 102 to the NPN 108 can include any of, an EAP-based procedure, a Certificate-based EAP-TLS procedure, and a username and password-based approach. The credential itself can be, for example, a username/password, a certificate, a PKI certificate, a public key, an access token, a subscriber profile (e.g. SIM profile), etc. In the latter case, the subscriber profile can be used where the operator of the PLMN_A 802 also manages/operates the ParkingNW 803 or other PNI-NPN as part of its network (i.e. with a shared RAN and shared core).

In some embodiments, the network information received in step 1303 also comprises frequency information indicating one or more frequencies used by the NPN 108. The frequency information can be an ARFCN.

In some embodiments, the first server 106 can also receive server information from the second server 110. The server information indicates or identifies the second server 110 or another server associated with the service provider that is to provide the service to the wireless device 102. The server information can be an IP address, a URL, or some other type of identifier.

In step 1305, the first server 106 sends the received network information for the NPN to the wireless device 102. The wireless device 102 can use the network information to connect to, and authenticate with, the NPN.

In embodiments where the first server 106 also receives server information from the second server 110, the first server 106 can send this information to the wireless device 102.

In some embodiments, the method can also comprise the first server 106 receiving data, instructions and/or commands relating to the service from the server that is to provide the service to wireless devices 102. In this case, the first server 106 can transmit the data, instructions and/or commands to the wireless device 102 via the NPN 108.

In some embodiments, the first server 106 can send an instruction or command to use the service to the wireless device 102 via the public communication network 104.

In some embodiments, following receipt of an indication from the service provider that the service is complete, the first server 106 can send a disconnect notification to the wireless device 102 via the NPN 108. The disconnect indication indicates that the wireless device 102 is to disconnect from the NPN 108 and to reconnect to the public communication network 104.

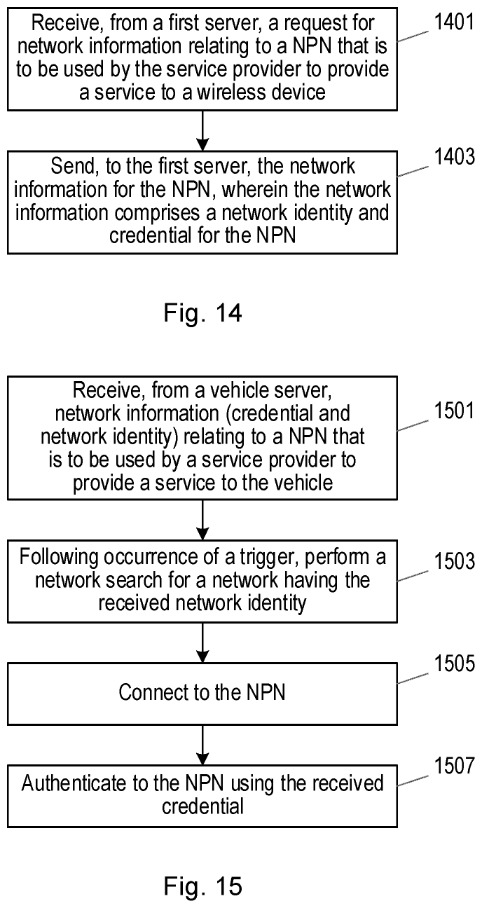

FIG. 14 is a flow chart illustrating a method according to various embodiments performed by a second server. The second server may perform the method in response to executing suitably formulated computer readable code. The computer readable code may be embodied or stored on a computer readable medium, such as a memory chip, optical disc, or other storage medium. The computer readable medium may be part of a computer program product.

In step 1401, the second server 110 receives a request for network information relating to a NPN 108 that is to be used by the service provider to provide a service to a wireless device 102. The request is received from a first server 106. The wireless device 102 may be a UE. The wireless device 102 may be, or be part of, a vehicle.

In step 1403, the second server 110 sends the network information for the NPN to the first server 106. The network information comprises at least a network identity and credential for the NPN. In some embodiments, the credential is unique to the wireless device 102. In some embodiments, the credential is unique to the service session (i.e. the session to be used to provide a specific instance of the service to the wireless device 102). In other embodiments, a group of wireless devices 102 (or all wireless devices 102) may share a single credential.

The credential may be of any suitable type, i.e. suitable for authenticating a wireless device 102 with the NPN 108. Authentication procedures that can be used to authenticate a wireless device 102 to the NPN 108 can include any of, an EAP-based procedure, a Certificate-based EAP-TLS procedure, and a username and password-based approach. The credential itself can be, for example, a username/password, a certificate, a PKI certificate, a public key, an access token, a subscriber profile (e.g. SIM profile), etc. In the latter case, the subscriber profile can be used where the operator of the PLMN_A 802 also manages/operates the ParkingNW 803 or other PNI-NPN as part of its network (i.e. with a shared RAN and shared core).

In some embodiments, the network information sent in step 1403 also comprises frequency information indicating one or more frequencies used by the NPN 108. The frequency information can be an ARFCN.

In some embodiments, the second server 110 can also send server information to the first server 106. The server information indicates or identifies the second server 110 or another server associated with the service provider that is to provide the service to the wireless device 102. The server information can be an IP address, a URL, or some other type of identifier.

In some embodiments, the second server 110 can send a trigger to the first server 106 that the wireless device 102 is to connect to the NPN 108. The trigger can be sent in response to detecting that the wireless device 102 is located at, is within a predetermined distance of, or heading towards, a predetermined location (such as a car park, hotel, etc.).

In some embodiments, after the wireless device 102 connects to the NPN 108, the second server 110 can provide the service to the wireless device 102 via the NPN 108. Providing the service can comprise the second server 110 sending data, instructions and/or commands to the first server 106. Alternatively, or in addition, providing the service can comprise the second server 110 sending data, instructions and/or commands to the wireless device 102 via the NPN 108.

In some embodiments, the second server 110 can send an indication that the service for a wireless device 102 is complete. This indication can be sent to the first server 106.

FIG. 15 is a flow chart illustrating a method according to various embodiments performed by a vehicle. The vehicle may perform the method in response to executing suitably formulated computer readable code. The computer readable code may be embodied or stored on a computer readable medium, such as a memory chip, optical disc, or other storage medium. The computer readable medium may be part of a computer program product.

At the start of the method, the vehicle 102 is connected to a public communication network 104. In step 1501, the vehicle 102 receives, from a vehicle server 106, network information relating to a NPN 108 that is to be used by a service provider to provide a service to the vehicle 102. The network information comprises at least a network identity of the NPN and a credential for the NPN. The vehicle server 106 is a server that is trusted by the vehicle 102, for example the vehicle server 106 can be a managing server that is operated by the manufacturer of the vehicle 102, or operated by a fleet operator to which the vehicle 102 belongs.

The service provided by the service provider may be an autonomous parking service for the vehicle 102, and/or a service for autonomous driving of the vehicle 102.

In some embodiments, the public communication network 104 and the NPN 108 are operated by different network operators.

In some embodiments, the credential is unique to the vehicle 102. In some embodiments, the credential is unique to the service session (i.e. the session to be used to provide a specific instance of the service to the vehicle 102). In other embodiments, a group of vehicles 102 (or all vehicles 102) may share a single credential.

The credential may be of any suitable type, i.e. suitable for authenticating a vehicle 102 with the NPN 108. Authentication procedures that can be used to authenticate a vehicle 102 to the NPN 108 can include any of, an EAP-based procedure, a Certificate-based EAP-TLS procedure, and a username and password-based approach. The credential itself can be, for example, a username/password, a certificate, a PKI certificate, a public key, an access token, a subscriber profile (e.g. SIM profile), etc. In the latter case, the subscriber profile can be used where the operator of the PLMN_A 802 also manages/operates the ParkingNW 803 or other PNI-NPN as part of its network (i.e. with a shared RAN and shared core).

In some embodiments, the network information relating to the NPN 108 also comprises frequency information indicating one or more frequencies used by the NPN 108. The frequency information can be an ARFCN.

In some embodiments, the vehicle 102 can also receive server information from the vehicle server 106. The server information indicates or identifies a second server 110 associated with the service provider that is to provide the service to the vehicle 102. The server information can be an IP address for the second server 110, a URL for the second server 110, or some other identifier for the second server 110.

In step 1503, which occurs following the occurrence of a trigger, the vehicle 102 performs a network search for a network having the received network identity (i.e. the vehicle 102 searches for NPN 108). Step 1503 can be considered to involve the vehicle 102 switching into a ‘NPN access mode’ where the vehicle 102 aims to connect to a NPN rather than a public communication network. In embodiments where the network information includes frequency information for the NPN 108, the network search can be performed on the one or more frequencies.

The trigger may be a request or input by a user of the vehicle 102 to use the service. The trigger may also or alternatively be the vehicle 102 being located at, within a predetermined distance of, or heading towards, a predetermined location (e.g. a car park). The trigger may also or alternatively be the receipt, via the public communication network 104, of an instruction or command to use the service from the vehicle server 106.

In step 1505, the vehicle 102 connects to the NPN 108, and in step 1507 the vehicle 102 authenticates to the NPN 108 using the received credential.

In some embodiments, the vehicle 102 can then use the service via the NPN 108. In some embodiments, using the service comprises receiving data, instructions and/or commands from the vehicle server 106 via the NPN 108. In alternative embodiments, using the service comprises receiving data, instructions and/or commands from the second server 110 via the NPN 108.

In some embodiments, the vehicle 102 can receive a disconnect notification indicating that the vehicle 102 is to reconnect to the public communication network 104. In this case, the vehicle 102 can disconnect from the NPN 108, perform a network search for the public communication network 104, and reconnect to the public communication network 104. The disconnect notification can be received via the NPN 108 from one of the vehicle server 106, the second server 110 and another server associated with the service provider.

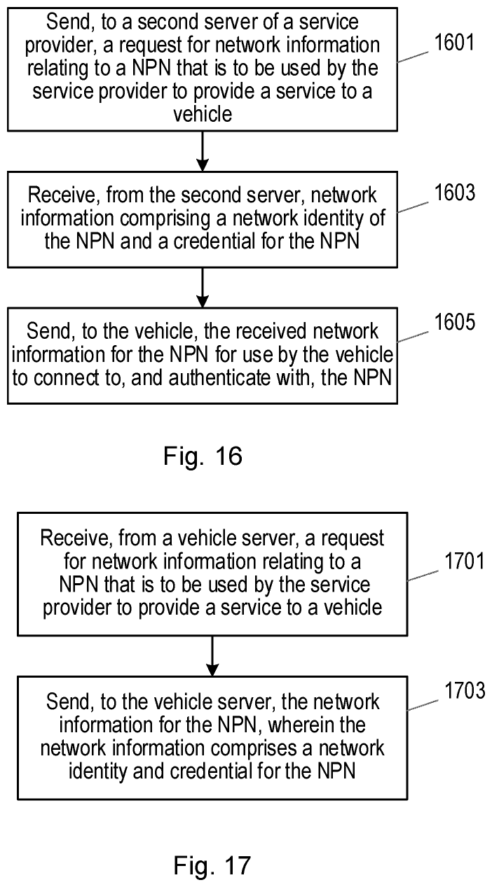

FIG. 16 is a flow chart illustrating a method according to various embodiments performed by a vehicle server. The vehicle server may perform the method in response to executing suitably formulated computer readable code. The computer readable code may be embodied or stored on a computer readable medium, such as a memory chip, optical disc, or other storage medium. The computer readable medium may be part of a computer program product.

In step 1601 the vehicle server 106 sends a request for network information relating to a NPN that is to be used by a service provider to provide a service to a vehicle 102. The request is sent to a second server 110 of the service provider.

The service provided by the service provider may be an autonomous parking service for the vehicle 102, and/or a service for autonomous driving of the vehicle 102.

In step 1603, the vehicle server 106 receives network information from the second server 110. The network information comprises at least a network identity of the NPN and a credential for the NPN. In some embodiments, the credential is unique to the vehicle 102. In some embodiments, the credential is unique to the service session (i.e. the session to be used to provide a specific instance of the service to the vehicle 102). In other embodiments, a group of vehicles 102 (or all vehicles 102) may share a single credential.

The credential may be of any suitable type, i.e. suitable for authenticating a vehicle 102 with the NPN 108. Authentication procedures that can be used to authenticate a vehicle 102 to the NPN 108 can include any of, an EAP-based procedure, a Certificate-based EAP-TLS procedure, and a username and password-based approach. The credential itself can be, for example, a username/password, a certificate, a PKI certificate, a public key, an access token, a subscriber profile (e.g. SIM profile), etc. In the latter case, the subscriber profile can be used where the operator of the PLMN_A 802 also manages/operates the ParkingNW 803 or other PNI-NPN as part of its network (i.e. with a shared RAN and shared core).

In some embodiments, the network information received in step 1603 also comprises frequency information indicating one or more frequencies used by the NPN 108. The frequency information can be an ARFCN.

In some embodiments, the vehicle server 106 can also receive server information from the second server 110. The server information indicates or identifies the second server 110 or another server associated with the service provider that is to provide the service to the vehicle 102. The server information can be an IP address, a URL, or some other type of identifier.

In step 1605, the vehicle server 106 sends the received network information for the NPN to the vehicle 102. The vehicle 102 can use the network information to connect to, and authenticate with, the NPN.

In embodiments where the vehicle server 106 also receives server information from the second server 110, the vehicle server 106 can send this information to the vehicle 102.

In some embodiments, the method can also comprise the vehicle server 106 receiving data, instructions and/or commands relating to the service from the server that is to provide the service to vehicles 102. In this case, the vehicle server 106 can transmit the data, instructions and/or commands to the vehicle 102 via the NPN 108.

In some embodiments, the vehicle server 106 can send an instruction or command to use the service to the vehicle 102 via the public communication network 104.

In some embodiments, following receipt of an indication from the service provider that the service is complete, the vehicle server 106 can send a disconnect notification to the vehicle 102 via the NPN 108. The disconnect indication indicates that the vehicle 102 is to disconnect from the NPN 108 and to reconnect to the public communication network 104.

FIG. 17 is a flow chart illustrating another method according to various embodiments performed by a second server. The second server may perform the method in response to executing suitably formulated computer readable code. The computer readable code may be embodied or stored on a computer readable medium, such as a memory chip, optical disc, or other storage medium. The computer readable medium may be part of a computer program product.

In step 1701, the second server 110 receives a request for network information relating to a NPN 108 that is to be used by the service provider to provide a service to a vehicle 102. The request is received from a vehicle server 106.

In step 1703, the second server 110 sends the network information for the NPN to the vehicle server 106. The network information comprises at least a network identity and credential for the NPN. In some embodiments, the credential is unique to the vehicle 102. In some embodiments, the credential is unique to the service session (i.e. the session to be used to provide a specific instance of the service to the vehicle 102). In other embodiments, a group of vehicles 102 (or all vehicles 102) may share a single credential.

The credential may be of any suitable type, i.e. suitable for authenticating a vehicle 102 with the NPN 108. Authentication procedures that can be used to authenticate a vehicle 102 to the NPN 108 can include any of, an EAP-based procedure, a Certificate-based EAP-TLS procedure, and a username and password-based approach. The credential itself can be, for example, a username/password, a certificate, a PKI certificate, a public key, an access token, a subscriber profile (e.g. SIM profile), etc. In the latter case, the subscriber profile can be used where the operator of the PLMN_A 802 also manages/operates the ParkingNW 803 or other PNI-NPN as part of its network (i.e. with a shared RAN and shared core).

In some embodiments, the network information sent in step 1703 also comprises frequency information indicating one or more frequencies used by the NPN 108. The frequency information can be an ARFCN.

In some embodiments, the second server 110 can also send server information to the vehicle server 106. The server information indicates or identifies the second server 110 or another server associated with the service provider that is to provide the service to the vehicle 102. The server information can be an IP address, a URL, or some other type of identifier.

In some embodiments, the second server 110 can send a trigger to the vehicle server 106 that the vehicle 102 is to connect to the NPN 108. The trigger can be sent in response to detecting that the vehicle 102 is located at, is within a predetermined distance of, or heading towards, a predetermined location (such as a car park, hotel, etc.).

In some embodiments, after the vehicle 102 connects to the NPN 108, the second server 110 can provide the service to the vehicle 102 via the NPN 108. Providing the service can comprise the second server 110 sending data, instructions and/or commands to the vehicle server 106. Alternatively, or in addition, providing the service can comprise the second server 110 sending data, instructions and/or commands to the vehicle 102 via the NPN 108.

In some embodiments, the second server 110 can send an indication that the service for a vehicle 102 is complete. This indication can be sent to the vehicle server 106.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1-78. (canceled)

79. A method of operating a vehicle that is connected to a public communication network, the method comprising:
receiving, from a vehicle server, network information relating to a non-public network (NPN) that is to be used by a service provider to provide a service to the vehicle, wherein the network information comprises a network identity of the NPN and a credential for the NPN;
following occurrence of a trigger, performing a network search for a network having the received network identity;
connecting to the NPN; and
authenticating to the NPN using the received credential.

80. The method as claimed in claim 79, wherein the network information further comprises frequency information indicating one or more frequencies used by the NPN, and wherein performing the network search comprises searching on the one or more frequencies.

81. The method as claimed in claim 79, wherein the method further comprises receiving, from the vehicle server, server information indicating a second server associated with the service provider that is to provide the service to the vehicle, and using the service via the NPN, wherein using the service via the NPN comprises receiving data, instructions, or commands from the second server associated with the service provider via the NPN.

82. The method as claimed in claim 79, wherein the method further comprises using the service via the NPN, and wherein using the service via the NPN comprises receiving data, instructions, or commands from the vehicle server via the NPN.

83. The method as claimed in claim 79, wherein the method further comprises:
receiving a disconnect notification indicating that the vehicle is to reconnect to the public communication network;
disconnecting from the NPN;
performing a network search for the public communication network; and
reconnecting to the public communication network.

84. The method as claimed in claim 83, wherein the disconnect notification is received, via the NPN, from the vehicle server or a server associated with the service provider.

85. The method as claimed in claim 79, wherein the trigger is one or more of:
a request or input by a user of the vehicle to use the service;
the vehicle being located at, within a predetermined distance of, or heading towards, a predetermined location; and
a receipt, via the public communication network, of an instruction or command to use the service from the vehicle server.

86. The method as claimed in claim 79, wherein the service is a service for provision of digital map data, autonomous parking of the vehicle, or autonomous driving of the vehicle.

87. A method of operating a vehicle server, the method comprising:
sending, to a second server of a service provider, a request for network information relating to a non-public network (NPN) that is to be used by the service provider to provide a service to a vehicle;
receiving, from the second server, network information comprising a network identity of the NPN and a credential for the NPN; and
sending, to the vehicle, the received network information for the NPN, for use by the vehicle to connect to and authenticate with the NPN.

88. The method as claimed in claim 87, wherein the method further comprises:
receiving, from the second server, server information indicating a server associated with the service provider that is to provide the service to vehicles; and
sending, to the vehicle, the received server information.

89. The method as claimed in claim 87, wherein the method further comprises:
following receipt of an indication from the service provider that the service is complete, sending a disconnect notification to the vehicle via the NPN, wherein the disconnect indication indicates that the vehicle is to disconnect from the NPN and to reconnect to the public communication network.

90. The method as claimed in claim 87, wherein the service is a service for provision of digital map data, autonomous parking of the vehicle, or autonomous driving of the vehicle.

91. A method of operating a second server of a service provider, the method comprising:
receiving, from a vehicle server, a request for network information relating to a non-public network (NPN) that is to be used by the service provider to provide a service to a vehicle; and
sending, to the vehicle server, the network information for the NPN, wherein the network information comprises a network identity and credential for the NPN.

92. The method as claimed in claim 91, wherein the method further comprises sending, to the vehicle server, server information indicating a server associated with the service provider that is to provide the service to the vehicles.

93. The method as claimed in claim 91, wherein the method further comprises sending, to the vehicle server, a trigger for the vehicle to connect to the NPN.

94. The method as claimed in claim 93, wherein the trigger is sent in response to detecting that the vehicle is located at, is within a predetermined distance of, or heading towards, a predetermined location.

95. The method as claimed in claim 91, wherein the method further comprises, after the vehicle connects to the NPN, providing the service to the vehicle via the NPN.

96. The method as claimed in claim 91, wherein the method further comprises sending, to the vehicle server, an indication that the service for the vehicle is complete.

97. The method as claimed in claim 91, wherein the service is a service for provision of digital map data, autonomous parking of the vehicle, or autonomous driving of the vehicle.

98. A vehicle configured to connect to a public communication network, the vehicle comprising:
at least one processor; and
a memory containing program code, wherein execution of the program code by the at least one processor causes the vehicle to:
receive, from a vehicle server, network information relating to a non-public network (NPN) that is to be used by a service provider to provide a service to the vehicle, wherein the network information comprises a network identity of the NPN and a credential for the NPN;
following occurrence of a trigger, perform a network search for a network having the received network identity;
connect to the NPN; and
authenticate to the NPN using the received credential.

99. A vehicle server, the vehicle server comprising:
at least one processor; and
a memory containing program code, wherein execution of the program code by the at least one processor causes the vehicle server to:
send, to a second server of a service provider, a request for network information relating to a non-public network (NPN) that is to be used by the service provider to provide a service to a vehicle;
receive, from the second server, network information comprising a network identity of the NPN and a credential for the NPN; and
send, to the vehicle, the received network information for the NPN for use by the vehicle to connect to, and authenticate with, the NPN.

100. A second server, the second server comprising:
at least one processor; and
a memory containing program code, wherein execution of the program code by the at least one processor causes the second server to:
receive, from a vehicle server, a request for network information relating to a non-public network (NPN) that is to be used by a service provider to provide a service to a vehicle; and
send, to the vehicle server, the network information for the NPN, wherein the network information comprises a network identity and credential for the NPN.
